(19) United States
(12) Patent Application Publication
(10) Pub. No.: US 2005/0252456 A1
(43) Pub. Date: Nov. 17, 2005

(54) Particulate dispenser

(75) Inventor: Anthony J. Allis, Bronx, NY (US)

Correspondence Address: OSTROLENK FABER GERB & SOFFEN, 1180 AVENUE OF THE AMERICAS, NEW YORK, NY, 100368403, US

(73) Assignee: Mag-Life LLC

(21) Appl. No.: 11/049,395

(22) Filed: Feb. 2, 2005

Related U.S. Application Data
(60) Provisional application No. 60/541,685, filed on Feb. 3, 2004.

(51) Int. Cl. A01K 61/02

(52) U.S. Cl. 119/51.04

(57) ABSTRACT

A particulate dispenser includes a housing for receiving particulate matter, such as fish food, to be dispensed, the housing having a perforated end through which the particulate matter may be discharged and an agitator for rotation within the housing. The agitator agitates the particulate matter, and sweeps the particulate matter against the perforated end, thereby forcing the particulate matter through the perforations.

### CROSS-REFERENCE TO RELATED APPLICATIONS

This application is based on and claims the benefit of U.S. Provisional Application No. 60/541,685, entitled “FISH FEEDER,” the entire disclosure of which is incorporated by reference herein.

### BACKGROUND OF THE INVENTION

The present invention relates to dry particulate dispensers and, more particularly, to a dry particulate dispenser for feeding fish.

Feeding fish in aquariums is an important step in their care. However, several problems are associated with proper fish feeding. For example, overfeeding fish may cause health problems and foul the aquarium water. Aggressive fish may quickly eat most of the food, leaving the smaller fish hungry. Food that is not eaten quickly enough may sink to the bottom and, after time, require cleaning. Accordingly, in order to assure continued health of the fish and good maintenance of the aquarium it is necessary that the fish always be fed with the proper amount of food.

### SUMMARY OF THE INVENTION

It is a specific object of the present invention, therefore, to provide a device for feeding fish at a constant rate with a uniform size of fish food such that the fish may be adequately fed without being overfed.

More broadly, it is an object of the present invention to provide a particulate dispensing device that is simple and economical to manufacture, easy to use, and can dispense any particulate matter in a controlled manner.

These and other objects are accomplished according to an embodiment of the invention by a particulate dispenser comprising a housing for receiving particulate matter to be dispensed. The housing has a perforated end through which the particulate matter may be discharged and an agitator which is mounted for rotation within the housing. The agitator is structured and arranged such that upon rotation the agitator agitates the particulate matter, and sweeps the particulate matter against the perforated end, thereby forcing the particulate matter through the perforations.

In accordance with one aspect of the invention the agitator comprises an elongated spring-like member having a first end rotatably mounted at the opposite end of the housing and a second free end extending toward the perforated end of the housing and wherein at least one blade-like element extends substantially perpendicularly from the elongated spring-like member at a location adjacent the free end.

In accordance with another aspect of the invention, the perforated end comprises a fixed perforated disk and a rotatable perforated disk arranged with respect to the fixed disk such that rotation of the rotatable disk changes the effective size of the perforations of the fixed disk. This enables control over the size and rate of discharge of the dispensed material.

In accordance with still another aspect of the invention, the dispenser is a fish feeder for dispensing particulate fish food and comprises a pistol-shaped housing including a grip portion and a substantially cylindrical barrel extending at an angle from the grip portion, the barrel being adapted to receive particulate fish food to be dispensed and having a perforated end through which the particulate fish food may be discharged. An agitator, rotatably mounted within the barrel, agitates the particulate fish food, and sweeps the particulate fish food against the perforated end, thereby forcing the particulate fish food through the perforations. A motor for rotating the agitator is disposed in the barrel and the grip-portion is adapted to receive a battery and connect the battery to the motor through a switch located in the grip-portion.

Other features and advantages of the present invention will become apparent from the following description of the invention which refers to the accompanying drawings.

### BRIEF DESCRIPTION OF THE DRAWINGS

FIG. 1 is a sectional, plan view of a particulate dispenser illustrating certain features of the present invention.

FIG. 2 is an end view of the dispenser of FIG. 1.

FIG. 3 is an end view of an alternative embodiment of a particulate dispenser illustrating certain features of the present invention.

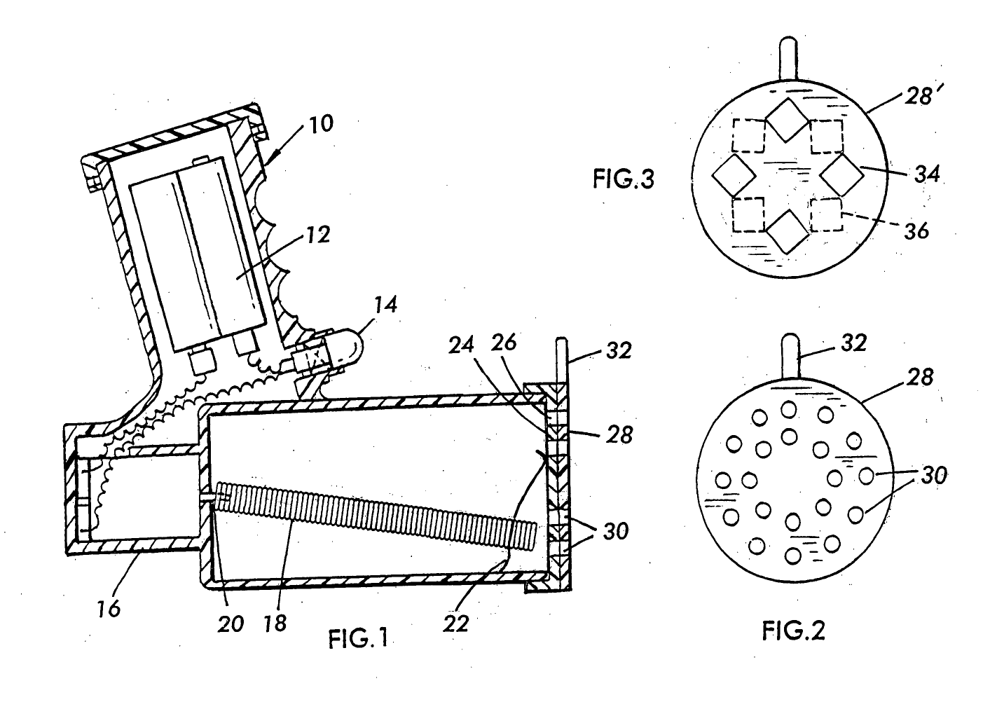

### DETAILED DESCRIPTION OF PREFERRED EMBODIMENTS OF THE INVENTION

Referring now to the drawings, there is shown an embodiment of a particulate dispenser in the form of a fish feeder 1 illustrating certain features of the invention. The feeder 1 includes a housing 10, which is shown as pistol-shaped but may be any suitable shape. The housing 10 contains a battery 12, a push-button switch 14, a motor 16, an agitator in the form of a spring 18 attached to the shaft 20 of the motor 16, one or more nylon blades 22 attached to the spring 18 and an outlet dispenser in the form of a fixed disk 24 having a plurality of holes 26. Advantageously, a rotatable disk 28 having a plurality of holes 30 is provided to cooperate with the fixed disk 24 to enable size adjustment of the dispensed particulate matter. A lever 32 is provided to facilitate turning of the disk 28.

The feeder 1 dispenses food at a constant rate and of uniform size range from the time it is full until it is nearly empty. To ensure a constant output rate, a combination of vibration, agitation and sweeping is used. The spring 18 is stiff enough so it bends only slightly under load, but bends enough so that randomness is added. This assures that there are no dead spots in the housing which would allow a food build up in the housing. The nylon blade 22 is mounted almost perpendicular to the spring 18, about 15 degrees off, so as to provide a lifting effect with the sweeping end just making trailing contact with the food dispensing holes 26, 30 as it spins. The lifting keep the dispensing holes 26, 30 clear as food is dispensed.

The food may be in the form of flakes or pellets. When the food is in the form of flakes, the blade 22, in addition to aiding in lifting and sweeping, also chops the flakes. As the blade 22 spins, the food kind of floats in air and the smaller pieces fall past it to the cleared holes 26, 30 and then the food is helped out by the sweeping effect of the blade 22 against the holes 26, 30 which do the final sizing by forcing the part of the flake out that fits. This action cause the spring 18 to distort a controlled amount while it also helps stabilize and guide the spring 18 as it keeps the spring 18 from contacting the wall of the feeder housing as it spins. The motor 16 is mounted slightly off center as is the spring 18.

Food size and rate can be adjusted by turning the rotatable disk 28 to make the openings defined by the overlapping holes 26, 30 holes larger, smaller or to seal them off when not in use (i.e., to change the “effective size” of the holes 26). When the food is in the form of flakes, the openings are adjusted for the desired size of the flakes it is desired to dispense; when the food is in the form of pellets, the openings are adjusted to the size of the pellets.

Referring now to FIG. 3, there is shown an alternative embodiment in which diamond shaped holes 34 are formed in the rotatable disk 28′, in lieu of the circular holes 30 employed in FIG. 2. Similar diamond shaped holes 36 are also formed in the fixed disk. The diamond shaped holes are arranged such that the diagonal between opposite vertices of each diamond shaped hole are radially directed to the center of its respective disk.

The feeder 1 can be run automatically by timer and set for any number of feedings per day of desired amount set by hole size and run time per feeding. The feeder can hold sufficient food for weeks or more. The automated embodiment works the same as the manual version but is mounted above the fish tank and has a manual mode as well.

Although the present invention has been described in relation to particular embodiments thereof, many other variations and modifications and other uses will become apparent to those skilled in the art. For example, the feeder, in lieu of being electrically powered, may be manually powered to reduce cost and eliminate the need for batteries or other power adapters. Thus, for example, instead of a push button electrical switch, a manually operated trigger coupled to the spring through a suitable mechanical linkage (e.g., a rack and pinion), can be used to rotate the spring. Further, it should be appreciated that although the specific embodiment of the invention described herein is used as a fish feeder, the invention it not so limited and may be used to dispense any type of particulate matter. It is preferred, therefore, that the present invention be limited not by the specific disclosure herein, but only by the appended claims.

1. A particulate dispenser, comprising:
a housing for receiving particulate matter to be dispensed, the housing having a perforated end through which the particulate matter may be discharged; and
an agitator mounted for rotation within the housing, the agitator being structured and arranged such that upon rotation the agitator agitates the particulate matter, and sweeps the particulate matter against the perforated end, thereby forcing the particulate matter through the perforations.

2. A particulate dispenser, comprising:
a housing for receiving particulate matter to be dispensed, the housing having a perforated end through which the particulate matter may be discharged;
an agitator mounted for rotation within the housing, the agitator being structured and arranged such that upon rotation the agitator agitates the particulate matter, and sweeps the particulate matter against the perforated end, thereby forcing the particulate matter through the perforations; and
a motor within the housing for rotating the agitator

3. A particulate dispenser, comprising:
a substantially cylindrical housing for receiving particulate matter to be dispensed, the housing having a perforated end through which the particulate matter may be discharged;
an agitator rotatably mounted at an end opposite to the perforated end for rotation about a substantially longitudinal axis within the housing, the agitator being structured and arranged such that upon rotation the agitator agitates the particulate matter, and sweeps the particulate matter against the perforated end, thereby forcing the particulate matter through the perforations; and
a motor within the housing for rotating the agitator.

4. A particulate dispenser in accordance with claim 3, wherein the agitator comprises an elongated spring-like member extending from the opposite end toward the perforated end.

5. A particulate dispenser in accordance with claim 3, wherein the agitator comprises an elongated spring-like member having a first end rotatably mounted at the opposite end of the housing and a second free end extending toward the perforated end of the housing and wherein at least one blade-like element extends substantially perpendicularly from the elongated spring-like member at a location adjacent the free end.

6. A particulate dispenser in accordance with claim 5, wherein the elongated spring-like member extends from the opposite end toward the perforated end at an angle to a central longitudinal axis of the housing.

7. A particulate dispenser in accordance with claim 6, wherein the elongated spring-like member is rotatably mounted at the opposite end at a position offset from the central longitudinal axis of the housing.

8. A particulate dispenser in accordance with claim 3, wherein the perforated end comprises a fixed perforated disk and a rotatable perforated disk arranged with respect to the fixed disk such that rotation of the rotatable disk changes the effective size of the perforations of the fixed disk.

9. A fish feeder for dispensing particulate fish food, comprising:
a pistol-shaped housing including a grip portion and a substantially cylindrical barrel extending at an angle from the grip portion, the barrel being adapted to receive particulate fish food to be dispensed and having a perforated end through which the particulate fish food may be discharged;
an agitator rotatably mounted at an end opposite to the perforated end for rotation about a substantially longitudinal axis within the barrel, the agitator being structured and arranged such that upon rotation the agitator agitates the particulate fish food, and sweeps the particulate fish food against the perforated end, thereby forcing the particulate fish food through the perforations; and
a motor within the barrel for rotating the agitator.

10. A fish feeder for dispensing particulate fish food according to claim 9, wherein the grip-portion is adapted to receive a battery and connect the battery to the motor through a switch located in the grip-portion.

11. A fish feeder for dispensing particulate fish food according to claim 9, wherein the agitator comprises an elongated spring-like member having a first end rotatably mounted at the opposite end of the barrel and a second free end extending toward the perforated end of the barrel and wherein at least one blade-like element extends substantially perpendicularly from the elongated spring-like member at a location adjacent the free end.

12. A fish feeder for dispensing particulate fish food according to claim 11, wherein the elongated spring-like member extends from the opposite end toward the perforated end at an angle to a central longitudinal axis of the barrel.

13. A fish feeder for dispensing particulate fish food according to claim 12, wherein the elongated spring-like member is rotatably mounted at the opposite end at a position offset from the central longitudinal axis of the barrel.

14. A fish feeder for dispensing particulate fish food according to claim 13, wherein the perforated end comprises a fixed perforated disk and a rotatable perforated disk arranged with respect to the fixed disk such that rotation of the rotatable disk changes the effective size of the perforations of the fixed disk.
